(19) United States
(12) Patent Application Publication
(10) Pub. No.: US 2009/0064138 A1
(43) Pub. Date: Mar. 5, 2009

(54) APPARATUS, SYSTEM, AND METHOD FOR GATHERING TRANSACTION STATISTICS DATA FOR DELIVERING TRANSACTION STATISTICS DATA AS JAVA OBJECTS VIA JMX NOTIFICATION

(75) Inventors: Richard Arcuri, Newton, NJ (US); Mohammad Khatibi, Richmond Hill (CA); Daniel A. Nita, Richmond Hill (CA); Olena Woolf, Toronto (CA)

Correspondence Address: Kunzler & McKenzie, 8 EAST BROADWAY, SUITE 600, SALT LAKE CITY, UT, 84111, US

(73) Assignee: International Business Machines Corporation, Armonk, NY (US)

(21) Appl. No.: 11/849,037

(22) Filed: Aug. 31, 2007

(51) Int. Cl. G06F 9/445

(52) U.S. Cl. 718/1

(57) ABSTRACT

An apparatus, system, and method are disclosed for gathering transaction statistics data for a real time transaction system that delegates data persistence of the transaction statistics data to one or more clients by utilizing a JMX notification system. Specifically, transaction statistics data is collected in real time for each transaction executed by a real time transaction system; a JMX notification is generated that includes the transaction statistics data; and an MBean server broadcasts the JMX notification object to listeners, which then capture and persist the transaction statistics data on the client side, thereby minimizing the impact of data logging on the transaction system.

### BACKGROUND OF THE INVENTION

1. Field of the Invention

This invention relates to gathering and persisting transaction statistics data and more particularly relates to gathering and persisting transaction as Java objects via JMX notification.

2. Description of Related Art

Reporting and analysis play a very important aspect in business and are viewed as a core requirement for an enterprise application. There are many BI (Business Intelligence) reporting products that provide reporting functionality by accessing data, formatting it, and producing reports for capacity planning, budgeting, forecasting, consolidation, and financial analysis.

Typically these reports require accessing operational data. However, for the sake of performance it is best not to run reporting tools against an operational database as such tools may degrade performance. Conventional art attempts to solve this problem by persisting the transaction statistics data during transaction execution by writing the data to a log or database. In order to minimize the performance impact of logging the transaction statistics data, the transaction statistics data is usually cached and written out asynchronously by using separate threads.

However, this approach has several drawbacks. First, all the transaction statistics data for all transactions is persisted, and therefore may require a large amount of storage space. Because clients don't have access to control the caching of transaction statistic data, the clients are unable to define a period of time during which to record the transaction statistics data that the client is interested in. Furthermore, there is also a problem of managing the size of the repository where the transaction statistics data is stored, even if that repository is used as transient storage.

A second drawback of the conventional approach is that by the time a client receives the transaction statistics data, the original data format of the data is lost. Initially, the transaction statistics data to be reported is represented by Java objects, but when the data is stored in a transient persistent repository, the Java objects are converted into and stored as strings or text. Therefore, handling and processing of the data becomes more difficult.

Additionally, the conventional art lacks a solution to provide a separate source of administrative type reporting data that could be used to build reports and perform analysis on the client side. The present invention attempts to solve the problems found in the conventional art.

### SUMMARY OF THE INVENTION

From the foregoing discussion, it should be apparent that a need exists for an apparatus, system, and method for gathering transaction statistics data for a real time transaction system that delegates data persistence of the transaction statistics data to one or more clients. Beneficially, such an apparatus, system, and method would allow the performance impact on a transaction system to be minimized.

Generally, the present invention produces transaction statistics data for each transaction in a transaction system, and makes that data available to outside clients with minimal performance degradation. The delivery mechanism for the reporting data is a JMX (Java Management Extension) notification. Transactional statistics data may be encapsulated as a JMX notification in the form of a Java object, and an MBean (Managed Bean) may be used to issue the JMX notification. Then, an MBean server may be used to broadcast the JMX notification to listening clients that capture and persist the transaction statistics data for use by business intelligence tools.

The apparatus for gathering transaction statistics data for a real time transaction system that delegates data persistence of the transaction statistics data to one or more clients is provided with a plurality of modules configured to functionally execute the necessary steps of: collecting transaction statistics data in real time for each transaction executed by a real time transaction system; generating a JMX notification object that includes the transaction statistics data; sending JMX notification object to a managed bean (MBean) managed by an MBean server; and broadcasting the JMX notification object by way of the MBean server to one or more listeners that subscribes to messages from the real time transaction system and wherein the one or more listeners persist the transaction statistics data for the JMX notification object based on listener defined persistence criteria.

In one embodiment, the transaction statistics data is in the form of a java object with a hierarchy of nested internal objects. In a further embodiment, the apparatus is further configured to register a listener a single time to subscribe to messages from the transaction system such that the listener receives a broadcast of all JMX notification objects broadcasted by the managed bean (MBean) server.

In one embodiment, the listener specifies a time interval as part of the listener defined persistence criteria during which the listener gathers and persists the transaction statistics data. In a further embodiment, the transaction system may be located within a Java Virtual Machine (JVM) and at least one of the one or more listeners may be a remote listener located in a separate JVM such the remote listen remotely receives the transactional statistics data.

A system of the present invention is also presented for gathering transaction statistics data for a real time transaction system that delegates data persistence of the transaction statistics data to one or more clients. The system may be embodied with a Java Virtual Machine (JVM) comprising a real time transaction system configured to manage enterprise transactions; one or more client listeners in electronic communication with the transaction system; and a transaction program comprising the logic necessary to perform the operations of: collecting transaction statistics data in real time for each transaction executed by the real time transaction system wherein the transaction statistics data is in the form of a java object with a hierarchy of nested internal objects; generating a JMX notification object that includes the transaction statistics data; sending the JMX notification object to a managed bean (MBean) managed by an MBean server; registering each client listener a single time to subscribe to messages from the transaction system such that the listener receives a broadcast of all JMX notification objects broadcasted by the managed bean (MBean) server; and broadcasting the JMX notification object by way of the MBean server to the one or more client listeners wherein the one or more client listeners persist the transaction statistics data for the JMX notification object based on client listener defined persistence criteria and wherein the listener specifies a time interval as part of the listener defined persistence criteria during which the listener gathers and persists the transaction statistics data such that the transaction system delegates data persistence of the transaction statistics data to the one or more client listeners so as to relieve the processing burden of the transaction system.

A method of the present invention is also presented for gathering transaction statistics data for a real time transaction system that delegates data persistence of the transaction statistics data to one or more clients. The method in the disclosed embodiments substantially includes the steps necessary to carry out the functions presented above with respect to the operation of the described apparatus and system.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for gathering transaction statistics data for a real time transaction system that delegates data persistence of the transaction statistics data to one or more clients in accordance with the present invention;

FIG. 2 is a schematic block diagram illustrating one embodiment of a Remote MBean server in communication with a local MBean server; and

FIG. 3 is a schematic flow chart diagram illustrating one embodiment of a method for gathering transaction statistics data for a real time transaction system that delegates data persistence of the transaction statistics data to one or more clients in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

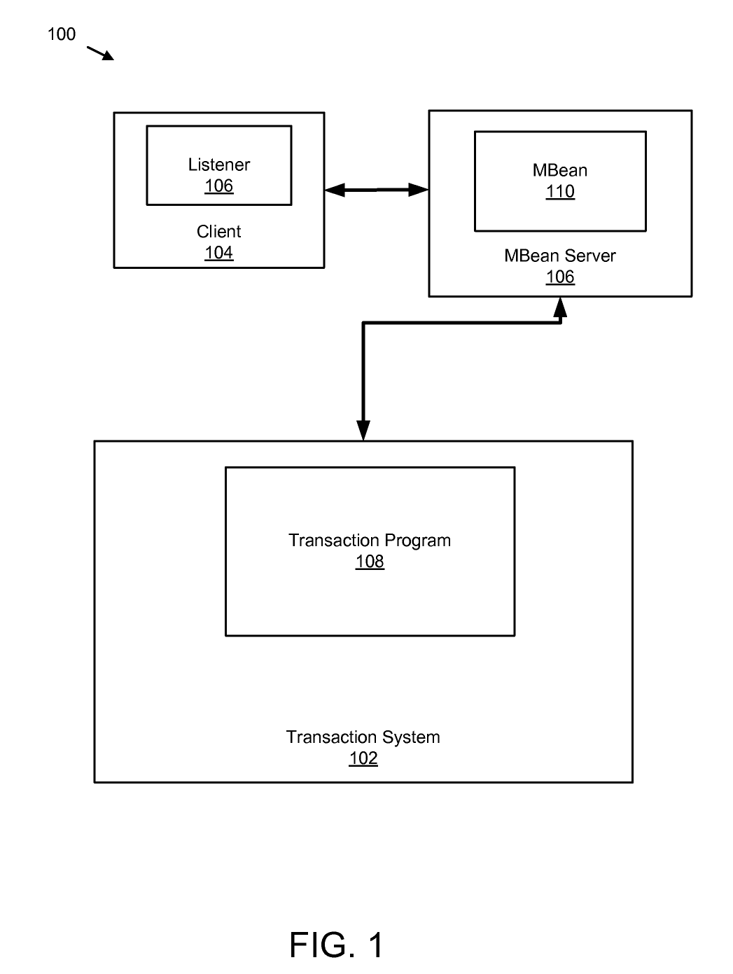

FIG. 1 is a schematic block diagram illustrating one embodiment of a system 100 for gathering transaction statistics data for a real time transaction system 102 that delegates data persistence of the transaction statistics data to one or more clients 104 in accordance with the present invention. In one embodiment, the system 100 includes a transaction system 102, a client 104, and an MBean (Managed Bean) Server 106.

The transaction system 102 is preferably any real time transactional system for which business intelligence reporting is allowed. An example of such a transaction system is the WebSphere Customer Center (WCC) 102 which is part of the WebSphere line of data management products available from IBM of Armonk, N.Y. The transaction system 102 is typically configured to collect, store, modify, and retrieve the transactions of an organization. A transaction is an event that generates or modifies data that is eventually stored in an information system. In at least one embodiment, the transaction system 102 may be implemented as a stand-alone transaction-processing Java application such that transaction statistics data may be collected from the stand-alone Java application.

The transaction system 102 includes a transaction program 108. In FIG. 1, the transaction program 108 is depicted as implemented on the transaction system 102. However, in various embodiments, the logic performed by the transaction program 108 may be implemented across different components of the system 100 including within the client 104 and the MBean server 106. In one embodiment, the transaction program 108 includes the logic necessary to perform the operations of collecting transaction statistics data in real time for each transaction executed by the real time transaction system 102. As the transaction system 102 processes a transaction, it may collect transaction statistics data as part of the transaction processing. Preferably, the collection of transaction statistics data imposes a minimal performance impact on the transaction system 102. In one embodiment, the transaction statistics data is initially captured at the end of a transaction as a TransactionData Java object. Furthermore, the transaction statistics data may be represented in the form of a java object with a hierarchy of nested internal objects.

In one specific embodiment, the transaction statistics data may be captured during the transaction execution by a component embedded into IBM's WebSphere Customer Center (WCC) request/response framework.

After a transaction is processed, the transaction program 108 generates a Java Management Extension (JMX) notification that includes the transaction statistics data. JMX is a Java technology that supplies tools for managing and monitoring applications, system objects, devices, and service oriented networks. These resources may be represented by objects called Managed Beans (MBeans). In a JMX application interface, an MBean is generally a type of JavaBean created with dependency injection, which means that one object uses a second object to provide a particular capacity. JMX has not previously been used as a medium for transferring business intelligence reporting responsibilities to a client 104 as is done with the present invention.

The JMX notification object is created by the MBean 110 which is managed by the MBean server 106. The MBean 110 is created for the purpose of sending JMX notifications which are configured to contain and transport the transaction statistics data to listeners 106. The MBean also notifies the MBean server when a JMX notification object has been created. A typical JMX notification, in one embodiment, may include the following details:

| Attribute | Value |
|---|---|
| ‘type’ | TransactionDataBroadcasterMBean.class.getName( ) |
| ‘timeStamp’ | System.currentTimeMillis( ) |
| ‘message’ | “Report Enablement Notification” |
| ‘source’ | TransactionDataBroadcasterMBean instance |
| ‘userData’ or | The instance of TransactionData |
| ‘TransactionData’ | |

Once the MBean 110 notifies the MBean server 106 of the creation of the JMX notification object, the MBean server 106 begins broadcasting JMX notification objects to one or more listeners 106 that subscribe to messages from the transaction system 102. Once the MBean server 106 has sent the JMX notification to the listeners 106, the MBean has fulfilled its processing responsibilities and the burden shifts to the client 104 to consume the JMX notification. In one specific embodiment, an MBean interface called TransactionDataBroadcasterMBean introduces a method ‘broadcast’ which is called to send JMX notifications to the listener 106.

In certain embodiments, the listener 110 registers with the MBean server 106 to subscribe to messages from the transaction system 102 such that the listener 110 receives a broadcast of all JMX notification objects broadcasted by the MBean server 106. Preferably, the listener 110 registers only a single time with the MBean server such that it subsequently receives broadcasts from the MBean server 106, and preferably, only one MBean listener 106 is registered for each application such that the reporting may be centralized at one location on the client side.

After a JMX notification is broadcast, it needs to be received by the listener 106 immediately after it is issued, otherwise the JMX notifications simply ‘disappear’, or are no longer available for capture. Because the JMX notification mechanism has this non-persistent nature, the client 104 has full control on when and for how long to listen to notifications, and the client 104 also has an unlimited decision power with regards to the choice of the repository in which to persist the transaction statistics data, as this logic resides in the listener 106 which is a client side of the implementation.

Once the listener 106 is registered, the listener 106 may be configured to capture only broadcasted JMX notifications that meet a set of defined persistence criteria. For example, a client 104 may be interested only in those events that occur during business hours, such as from 8 a.m. to 5 p.m. The listener 106 may be configured to capture and persist only the transaction statistics data generated during that time period. By capturing and persisting the transaction statistics data on the client side through the use of JMX notifications, any negative performance affects on the transaction system 102 can be minimized. Furthermore, by using JMX notification objects, the notifications can present the transaction statistics data in their original state as Java objects, which therefore allows the client 104 to receive the transaction statistics data as Java objects as well.

In one embodiment, the client 104 utilizes a log4j logging utility or similar utility recognized by those of skill in the art for the logging the transactions statistics data in a storage accessible by the client 104. In a further embodiment, the log4j logging utility may delegate the task of writing data logs to an individual log destination file. In this manner, the burden of persisting the transaction statistics data shifts from the transaction system 102 to the client 104.

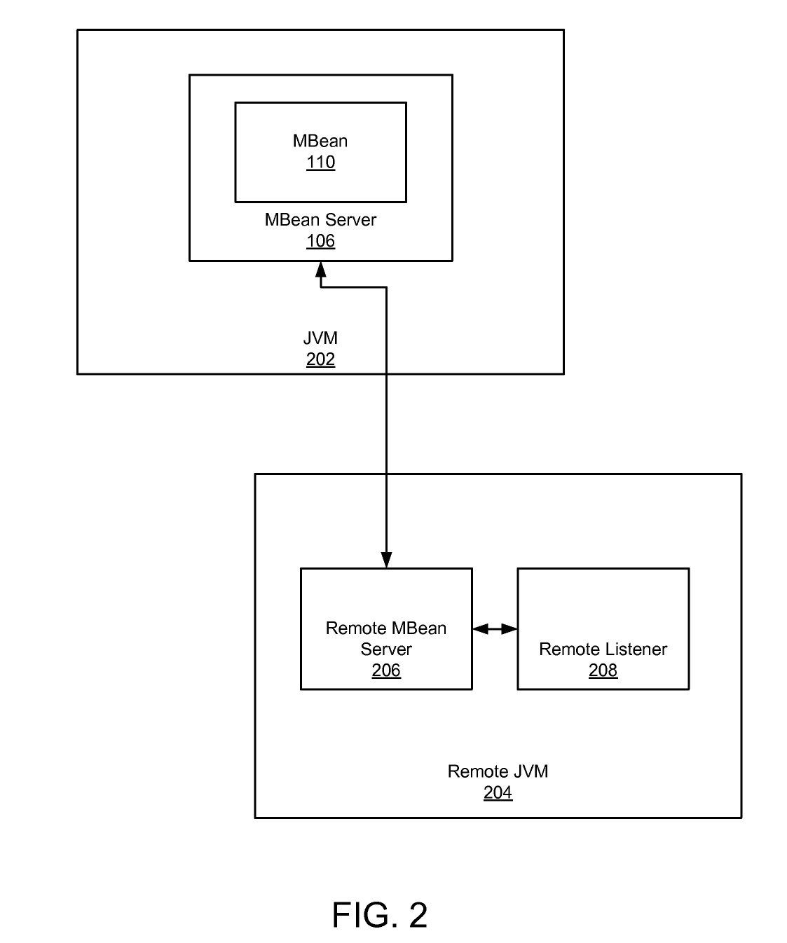

FIG. 2 is a schematic block diagram illustrating one embodiment of a Remote MBean server 206 in electronic communication with a local MBean server 106. In one embodiment, the MBean server 106 is implemented within a Java Virtual Machine (JVM) 202 and the MBean server 206 is implemented within a remote JVM 204. A JVM 202 and 204 is a set of computer software programs and data structures which implement a specific virtual machine model for handling Java bytecode.

In one embodiment, the local MBean server 106 delivers JMX notifications to a listener 106 either synchronously or asynchronously based on JMX specifications. In another embodiment, the remote listener 208 may be registered with the local MBean server 106 by an MBeanServerConnection running on a remote JVM 204. The MBeanServerConnection arranges for the JMX notifications to be sent from the local MBean Server 106 to the remote MBean server 206 and subsequently to the remote listener 208. In this manner, JMX notifications carrying transaction statistics data may be sent to a remote listener 208. The remote listener 208 may then specify persistence criteria for defining which JMX notifications to capture and log such that business intelligence operations may be performed on the persisted transaction statistics data.

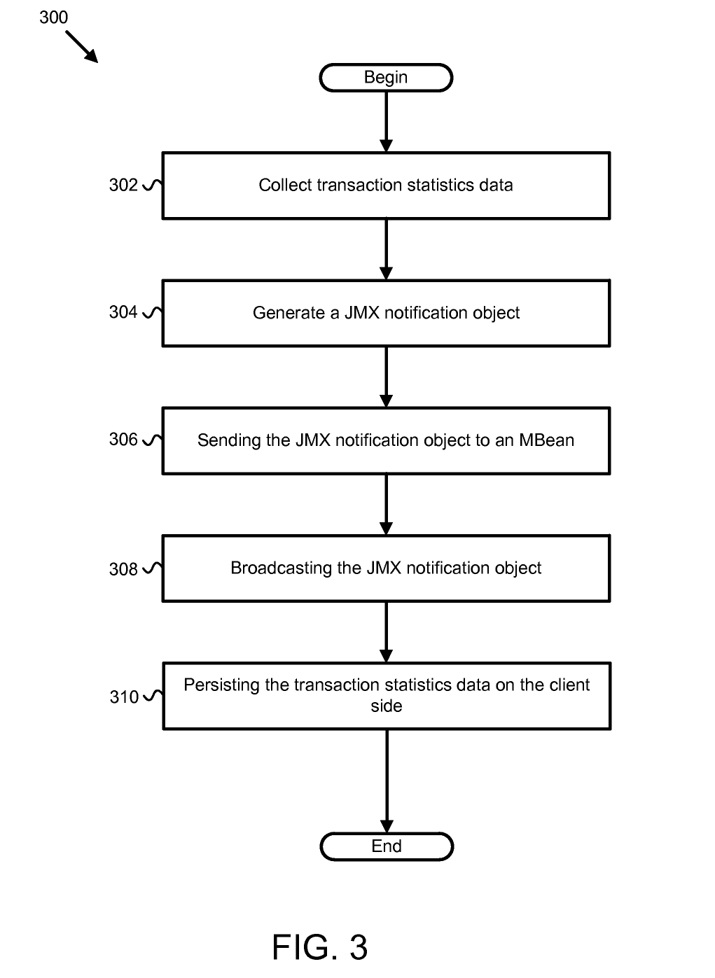

FIG. 3 is a schematic flow chart diagram illustrating one embodiment of a method 300 for gathering transaction statistics data for a real time transaction system 102 that delegates data persistence of the transaction statistics data to one or more clients 104 in accordance with the present invention. The method 300 in various embodiments, substantially includes the various implementations and embodiments described above with respect to the system 100. The method 300 begins when the transaction program 108 begins collecting 302 transaction statistics data in real time for each transaction executed by a real time transaction system 102. Typically, transaction statistics data is collected at the end of a transaction and is encapsulated in a TransactionData Java Object.

Next, a JMX notification object is generated 304 or issued by the MBean 110 and the MBean server 106 is notified of the creation of the JMX notification. The MBean server then broadcasts 308 the JMX notification to one or more listeners 106 wherein the listeners 106 subscribe to messages from the real time transaction system 102 and wherein the listeners 106 persist 310 the transaction statistics for the JMX notification object based on listener defined persistence criteria. In this manner, transaction statistics data persistence responsibilities are shifted to the client 104 such that the performance burden on the transaction system 102 is minimized. The method 300 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having computer usable program code stored on a tangible medium and executable on a processor to perform operations for gathering transaction statistics data for a real time transaction system that delegates data persistence of the transaction statistics data to one or more clients, the operations of the computer program product comprising:
collecting transaction statistics data in real time for each transaction executed by a real time transaction system;
generating a JMX (Java Management Extension) notification object that includes the transaction statistics data;
sending JMX notification object to a managed bean (MBean) managed by an MBean server; and
broadcasting the JMX notification object by way of the MBean server to one or more listeners that subscribes to messages from the real time transaction system and wherein the one or more listeners persist the transaction statistics data for the JMX notification object based on listener defined persistence criteria.

2. The computer program product of claim 1, wherein the transaction statistics data is in the form of a java object with a hierarchy of nested internal objects.

3. The computer program product of claim 1, further comprising registering a listener a single time to subscribe to messages from the transaction system such that the listener receives a broadcast of all JMX notification objects broadcasted by the managed bean (MBean) server.

4. The computer program product of claim 3, wherein the listener specifies a time interval as part of the listener defined persistence criteria during which the listener gathers and persists the transaction statistics data.

5. The computer program product of claim 4, wherein the JMX notification objects are broadcasted to at least one more remote listeners located in a separate Java Virtual Machine (JVM).

6. A system for gathering transaction statistics data for a real time transaction system that delegates data persistence of the transaction statistics data to one or more clients, the system comprising:
a Java Virtual Machine (JVM) comprising a real time transaction system configured to manage enterprise transactions;
one or more client listeners in electronic communication with the transaction system; and
a transaction program comprising the logic necessary to perform the operations of:
collecting transaction statistics data in real time for each transaction executed by the real time transaction system wherein the transaction statistics data is in the form of a java object with a hierarchy of nested internal objects;
generating a JMX notification object that includes the transaction statistics data;
sending the JMX notification object to a managed bean (MBean) managed by an MBean server;
registering each client listener a single time to subscribe to messages from the transaction system such that the listener receives a broadcast of all JMX notification objects broadcasted by the managed bean (MBean) server; and
broadcasting the JMX notification object by way of the MBean server to the one or more client listeners wherein the one or more client listeners persist the transaction statistics data for the JMX notification object based on client listener defined persistence criteria and wherein the listener specifies a time interval as part of the listener defined persistence criteria during which the listener gathers and persists the transaction statistics data such that the transaction system delegates data persistence of the transaction statistics data to the one or more client listeners so as to relieve the processing burden of the transaction system.
